(19) United States
(12) Patent Application Publication
(10) Pub. No.: US 2026/0321469 A1
(43) Pub. Date: Oct. 15, 2026

(54) HIGH MAGNETIZATION NICKEL-ZINC FERRITE MANUFACTURING METHODS AND DEVICES

(71) Applicants: SHOKRY IBRAHIM ABDELRAZAK SHAMSELDIN, EDMONTON (CA); MAHMOUD ELSAADANY, EDMONTON (CA); MOHAMED MAMDOUH MAHMOUD ALI, VERDUN (CA); SYED MUHAMMAD SIFAT, CORNWALL (CA); AHMED ABDELWAHED KISHK, ST. HUBERT (CA)

(72) Inventors: SHOKRY IBRAHIM ABDELRAZAK SHAMSELDIN, EDMONTON (CA); MAHMOUD ELSAADANY, EDMONTON (CA); MOHAMED MAMDOUH MAHMOUD ALI, VERDUN (CA); SYED MUHAMMAD SIFAT, CORNWALL (CA); AHMED ABDELWAHED KISHK, ST. HUBERT (CA)

(21) Appl. No.: 19/573,682

(22) Filed: Mar. 20, 2026

Related U.S. Application Data
(60) Provisional application No. 63/785,835, filed on Apr. 9, 2025.

(51) Int. Cl. H01F 1/11; C01G 53/40

(52) U.S. Cl. CPC H01F 1/11; C01G 53/40; C01P 2002/72; C01P 2002/85; C01P 2004/03; C01P 2006/42

(57) ABSTRACT

Iron oxide-containing magnetic ceramic materials, ferrites, can be magnetized to become permanent magnets and as most ferrites are not electrically conductive they are useful in multiple applications within aerospace, automotive, biomedical, communication, defense, radar, and satellite systems. Nickel zinc ferrites are of particular interest due to their high saturation magnetization of approximately 5300 Gauss but even this limits their use to specific frequency bands below 60 GHz. It would be beneficial for existing and future millimeter-wave applications to have ferrites with higher magnetization saturations.

### CROSS-REFERENCE TO RELATED APPLICATIONS

This patent application claims the benefit of priority to U.S. Provisional Patent Application 63/785,835, filed Apr. 9, 2025; the entire contents of which are incorporated herein by reference.

### FIELD OF THE INVENTION

This patent application relates to ferrite materials, more particularly to nickel zinc ferrite materials with high magnetization saturation and more particularly to nickel zinc ferrite materials for high frequency microwave devices.

### BACKGROUND OF THE INVENTION

Ferrites are iron oxide-containing magnetic ceramic materials which are ferrimagnetic such that they are attracted by magnetic fields and can be magnetized to become permanent magnets. Unlike many ferromagnetic materials, most ferrites are not electrically conductive, making them useful in multiple applications. Accordingly, ferrites are a common material for a wide range of applications within aerospace, automotive, biomedical, communication, defense, radar, and satellite systems.

Amongst ferrites, nickel zinc ferrites are of particular interest due to their high saturation magnetization as well exhibiting high magnetic permeability, mechanical strength, chemical stability, low coercivities and low dielectric losses. At present such ferrites have magnetization saturation of approximately 5300 Gauss which limits their use to specific frequency bands below 60 GHz.

Accordingly, it would be beneficial for existing and future millimeter-wave applications to have ferrites with higher magnetization saturations to support their use within millimeter-wave radar and communication device systems.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to ferrite materials, more particularly to nickel zinc ferrite materials with high magnetization saturation and more particularly to nickel zinc ferrite materials for high frequency microwave devices.

In accordance with an embodiment of the invention there is provided a device for processing microwave signals comprising:
an element formed from a compressed nickel zinc ferrite (NZF) powder formed with a predetermined geometry; wherein
the NZF has a saturation magnetization exceeding at least one of 8,000 Gauss, 9,000 Gauss and 10,000 Gauss; and
the NZF has the composition Ni₀0.5Zn₀0.5Fe₂O₄.

In accordance with an embodiment of the invention there is provided a method comprising:
forming an NZF powder with a process comprising:
   forming a paste comprising the NZF by employing a chemical co-precipitation process and filtering process;
   heating the initial paste under defined conditions to calcine the paste to yield an initial NZF particles;
   grinding the initial NZF particles to form the NZF powder;
   heating the NZF powder within other defined conditions;
forming the NZF powder into a defined geometry; and
compressing the NZF powder to form a ferrite element; wherein
the NZF has a saturation magnetization exceeding at least one of 8,000 Gauss, 9,000 Gauss and 10,000 Gauss; and
the NZF has the composition Ni₀0.5Zn₀0.5Fe₂O₄.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a manufacturing sequence for nickel zinc ferrite powder according to an embodiment of the invention with composition Ni_{0.5}Zn_{0.5}Fe₂O₄ (hereinafter referred to as NZF powder);

FIG. 2A depicts an X-ray diffraction (XRD) pattern of the NZF powder according to an embodiment of the invention fabricated using the process flow of FIG. 1;

FIG. 2B depicts a scanning electron microscope (SEM) image of the NZF powder according to an embodiment of the invention fabricated using the process flow of FIG. 1;

FIG. 2C depicts an energy-dispersive X-ray spectra (EDAX) of the NZF powder according to an embodiment of the invention fabricated using the process flow of FIG. 1;

FIG. 2D depicts the saturation magnetization of the NZF powder according to an embodiment of the invention fabricated using the process flow of FIG. 1;

FIG. 3A depicts a magnetic hysteresis loop (M-H) of the fabricated NZF powder according to an embodiment of the invention annealed at 1100° C. in a nitrogen atmosphere;

FIG. 3B depicts a magnetic hysteresis loop (M-H) of the fabricated NZF powder according to an embodiment of the invention annealed at 1100° C. in an argon with 3% hydrogen atmospheres;

FIG. 3C depicts a magnetic hysteresis loop (M-H) of the fabricated NZF powder according to an embodiment of the invention annealed at 1100° C. in a nitrogen with 3% hydrogen atmospheres; and

FIG. 3D depicts a comparison of the magnetization saturation for the NZF powder according to an embodiment of the invention under the environments of FIGS. 3A to 3C respectively;

FIGS. 4A to 4D depict a laboratory manufacturing procedure of ferrite powder to disk fabrication process comprising ferrite grinding, disposition of powder within a pellet, application of hydraulic pressure and after hydraulic compression;

FIG. 5A depicts an electrical characterization measurement setup for high-magnetization fabricated ferrite disks;

FIG. 5B depicts a simulated model of the electrical characterization of the fabricated ferrite using WR28 Waveguide and a coaxial Probe;

FIG. 5C depicts simulation and measurement results comparison of the NZF material according to an embodiment of the invention to predict its permittivity using the WR28 waveguide and coaxial probe;

FIG. 5D depicts simulated and measured phase of the NZF material according to an embodiment of the invention to predict its permittivity;

FIG. 6A depicts electrical characterization of the ferrite material according to an embodiment of the invention with 8500 G showing the permittivity of the fabricated NZF material;

FIG. 6B depicts electrical characterization of the ferrite material according to an embodiment of the invention with 8500 G showing the permeability of the fabricated NZF material;

FIG. 6C depicts the error percentage between measured and simulated responses versus frequency;

FIG. 7A depicts a 3D view of the bottom layer of a Ka-band circulator design used to demonstrate the NFZ ferrite material according to an embodiment of the invention;

FIG. 7B depicts a cross-section of the bottom layer of the Ka-band circulator design used to demonstrate the NFZ ferrite material according to an embodiment of the invention;

FIG. 7C depicts measurements of the Ka-band circulator design with the NZF material according to an embodiment of the invention;

FIG. 7D depicts measurements of change in field between a pair of ferrite elements formed using the NZF material according to an embodiment of the invention with changed in the magnetization of the permanent disk magnets within the Ka-band circulator; and

FIG. 7E depicts the simulated magnetic field distribution at the center of the junction of the Ka-band circulator using the NZF material according to an embodiment of the invention with an applied field of 2.96 T;

FIG. 8A depicts a schematic of a rectangular waveguide Ka-band circulator used to demonstrate the NZF material according to an embodiment of the invention with a ferrite magnetization of 4200 G;

FIG. 8B depicts images of the rectangular waveguide Ka-band circulator used to demonstrate the NZF material according to an embodiment of the invention with a ferrite magnetization of 4200 G with the fabricated ferrite is placed at the center junction;

FIG. 8C depicts an image of the assembled rectangular waveguide Ka-band circulator of FIG. 8B;

FIG. 8D depicts a schematic of the measurement setup for testing the Ka-band circulator depicted in FIGS. 8B and 8C; and

FIG. 8E depicts the simulated and measured performance of the Ka-band circulator depicted in FIGS. 8B and 8C using the NZF material according to an embodiment of the invention with a ferrite magnetization of 4200 G.

### DETAILED DESCRIPTION

The present invention is directed to ferrite materials, more particularly to nickel zinc ferrite materials with high magnetization saturation and more particularly to nickel zinc ferrite materials for high frequency microwave device.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Reference to terms such as “first”, “second”, etc. or “other”, “another”, “further”, etc. may be used herein to describe various devices, components, elements, or other items, such devices, components, elements, or other items are not employed to limit by these devices, components, elements, or other items etc. The terms are employed used to distinguish one of a type of item from another of the same or similar type of item within the description.

Any statement herein that a device, component, element or other item is “configured to” perform an action means that the device, component, element or other item—or some part (or parts) of the item are capable of performing such action and have the requisite physical and/or processing elements necessary to perform the action.

Ferrites are iron oxide-containing magnetic ceramic materials which are ferrimagnetic such that they are attracted by magnetic fields and can be magnetized to become permanent magnets. Unlike many ferromagnetic materials, most ferrites are not electrically conductive, making them useful in multiple applications. Accordingly, ferrites are a common material for a wide range of applications within aerospace, automotive, biomedical, communication, defense, radar, and satellite systems.

Amongst ferrites, nickel zinc ferrites are of particular interest due to their high saturation magnetization as well exhibiting high magnetic permeability, mechanical strength, chemical stability, low coercivities and low dielectric losses. These nickel zinc ferrites have a spinel crystal structure and have exhibited superior performance due to their electronic and magnetic properties that are essential for some applications. As such nickel zinc ferrites and other ferrites are employed within a number of microwave devices including, but not limited to, electromagnetic absorbers, circulators, phase shifters and switches. At present nickel zinc ferrites have magnetization saturation of approximately 5300 Gauss G which limits their use to specific frequency bands below 60 GHz. Accordingly, for applications above 60 GHz ferrites with higher magnetization saturations are required. Such higher magnetization saturation materials can also improve performance or allow reduced material requirements, footprints etc. for ferrite elements within devices at lower frequencies.

Within the prior art several processes have been reported for fabricating ferrite nanocrystalline powders which can then be formed into the desired geometries for these different devices and application. These include mechanical milling, hydro-thermal processing, sol-gel processing and chemical co-precipitation methods. The chemical co-precipitation method offers a low-cost manufacturing technique supporting mass production whilst ensuring the proper distribution of various metal ions resulting in smaller particle sizes compared to other manufacturing processes

Within the prior art different processes have been reported. For example, Rigby et al. in U.S. Pat. No. 4,407,313 entitled “Process for Making Fine Magnetic Ferrite Powder and Dense Ferrite Blocks” employed a co-precipitation method of an aqueous solution of metal ions and an ammonium oxalate solution, which was separated, washed, and dried. Narutani et al. reported in U.S. Pat. No. 5,698,145 entitled “Methods for Producing MN-ZN Ferrites” a process based upon sintering a binder and calcined mixture of iron oxide (Fe₂O₃), manganese oxide (MnO) and zinc oxide (ZnO). MZ-ZN ferrites of composition Ni_{X}Zn_{1-X}Fe_{2-Y-Z}Mn_{Y}Zr_{Z}O₄, with the value of X being in the range of 0.55 to 0.80, the value of Y being in the range of 0.001 to 0.20, and the value of Z being in the range of 0.001 to 0.04, were described by Ishikawa et al. in U.S. Pat. No. 5,876,618 entitled “Ni—Zn Type Ferrite” yielding a high saturation magnetization 4πMS of 5250 G where raw Ni—Zn ferrite powder was mixed for 64 hours before being fired at 850° C. in an oxygen environment after which the binder was added and the press-formed ferrite elements sintered for 5 hours in an oxygen atmosphere at 1350° C. Schoch et al. in U.S. Pat. No. 6,193,904 entitled “Method for Preparation of Ferrites” reported saturation magnetization 4πMS of 2150 G for Mn-doped magnesium ferrite calcined at 600° C. A Ni—Zn—Cu-based ferrite powder and ferrite sintered ceramic were reported by Okano et al. in U.S. Pat. No. 9,697,937 entitled “Ni—Zn—Cu-based Ferrite Particles, Green Sheet comprising the Ni—Zn—Cu-based Ferrite Particles and Ni—Zn—Cu-based Ferrite Sintered Ceramics” where the Ni—Zn—Cu-based ferrite was calcined between 850° C. to 950° C. in an ambient air atmosphere.

These prior art approaches offering what are known as “soft” ferrite materials compatible with microwave and RF applications. Other “hard” ferrite materials with high magnetization have also been reported with magnetizations above 100 emu/g such as those of Kaneko et al. in U.S. Patent Application 2014/0054491 entitled “Ferrite Particle and Production Method Thereof” which employ a highly orientated W-type ferrite (SrMe₂Fe₁₆O₂₇ where Me=Mg, Co, Ni or Zn), Yamamoto et al in U.S. Patent Application 2020/0265976 entitled “Magnetic Material and Method for Producing Same” employ a Fe_{100-X}(Co_{100-Y}M_{Y})_{X} compositions, where M is one or more of Zr, Hf, Ti, V, Nb, Ta, Cr, Mo, W, Mn, Cu, Zn, Si, and Ni with heating in a hydrogen atmosphere to yield a magnetization above 200 emu/g, and An et al. in U.S. Patent Application 2013/0033354 entitled “Ferrite Powder of Metal, Ferrite Metal Comprising the Same, and Multilayered Chip Components Comprising Ferrite Layer Using the Ferrite Material” employ a ferrite powder having a core-shell structure with an Fe core and metal oxides for the shell to provide an emu/g of 200. However, these “hard” ferrites that exceed 100 emu/g have the characteristics of permanent magnetization and/or large linewidth which limit their application to ferrite elements for transformers, inductors, reactor cores, motors, industrial machines, and generators etc.

Within the prior art techniques the ferrite powder fabrication processes require heat treatment to achieve the desired magnetization level where atmospheres such as oxygen, vacuum, hydrogen and nitrogen have been reported. Some of the prior art techniques have long and/or multiple sintering processes which increase the manufacturing time, cost, and complexity. Whilst other prior art has employed a range of chemical compositions, these have saturation magnetizations comparable to or lower than the prior art identified above which are sufficient for millimeter-wave RF components.

Accordingly, the inventors have established a manufacturing process for fabricating high-magnetization soft ferrites using the chemical co-precipitation method with heat treatment in a defined atmosphere where the fabricated powder can be mechanically pressed, e.g. with a hydraulic press machine, to form the desired ferrite element geometry, e.g. a disk, allowing their use within the millimeter-wave spectrum. In contrast to the highest commercially available saturation magnetization ferrite element of around 5300 G the inventors have achieved a saturation magnetization 4πMS of 9500 G.

Within the following description the sample preparation methods presented were those accessible to the inventors within an academic research laboratory or equivalent. It would be evident to one of skill in the art that other manufacturing systems may be employed at other commercial facilities etc. to support production of the novel nickel-zinc ferrites (NZFs) in larger quantities with or without automation etc.

### Sample Preparation, Filtration and Measurement

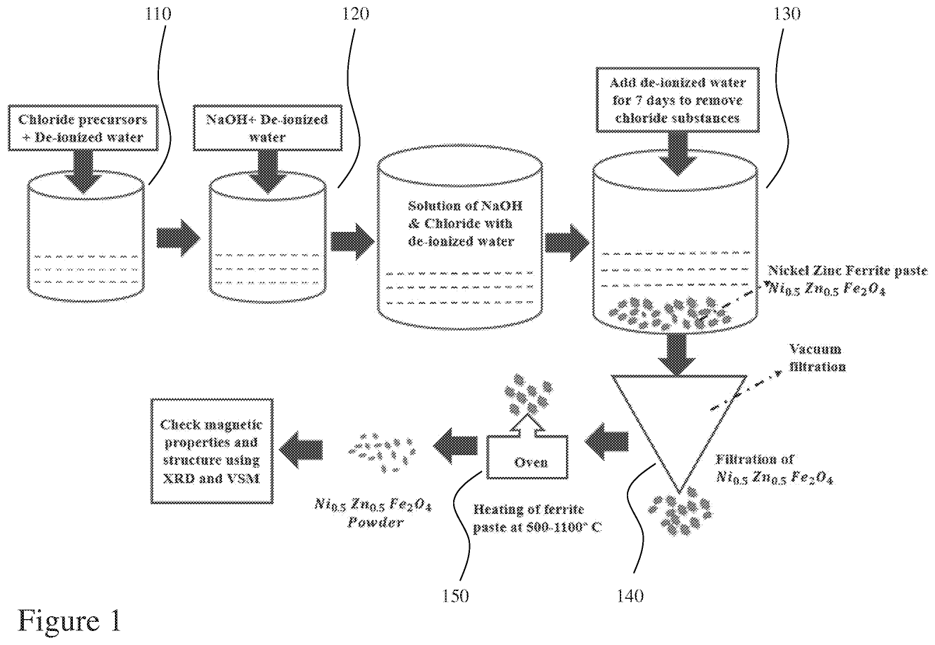

Referring to FIG. 1 there is depicted a schematic of the processing sequence established by the inventors for fabrication of initial samples of the nickel-zinc ferrites (NZFs) according to embodiments of the invention. This comprising a process with first to fifth Steps 110 to 150 which comprise:
First Step 110 mixing of chloride precursors with de-ionized water;
Second Step 120 mixing solution from first Step 100 with sodium hydroxide solution;
Third Step 130 removal of chloride substances remaining;
Fourth Step 140 filtration to isolate ferrite particles in paste form (ferrite paste); and
Fifth Step 150 heating ferrite paste to dry and form ferrite powder.

The chemical process within the embodiments of the invention described below exploits nickel chloride hydrate (NiCl₂·6H₂O), iron chloride (FeCl₃) and zinc chloride (ZnCl₂) according to Equation (1) below.

NiCl₂·6H₂O+0.5ZnCl₂+2FeCl₃+8NaOH=Ni_{0.5}Zn_{0.5}Fe₂O₄+8NaCl+7H₂O (1)

The required quantities of each chlorinated derivative were weighed separately in a vial with the help of a 50 g weighing scale. Typically, one beaker equipped with a stir bar was placed on top of the magnetic stirrer on which an ice bath was installed. 100 mL of deionized water was added inside the cold beaker, and the chlorinated chemical slowly and carefully poured down to prevent exothermic reactions. The chlorinated derivatives (NiCl₂·6H₂O), FeCl₃ or ZnCl₂) being used to form the acidic solution where the amounts were 2.86 g, 7.81 g, and 1.64 g, respectively. Each chemical's weight was calculated from the balanced Equation (1).

At first, NiCl₂·6H₂O was added to a 2 L beaker containing 100 mL of deionized water while stirring it with a stir bar using the magnetic stirrer at a constant speed of 1500 RPM. The procedure was repeated with the two other chlorinated congeners (FeCl₃ and ZnCl₂) in two distinct 600 mL beakers to yield three acidic solutions. The required amount of NaOH pellets (7.70 g) was carefully weighed under the fume hood, directly inside the vial, (it must be quickly capped after measurement to prevent air moisture absorption). One 600 mL beaker equipped with a stir bar is placed on top of the magnetic stirrer on which an ice bath is already installed. 100 mL of deionized water was added inside the cold beaker, and the NaOH slowly and carefully poured down to prevent exothermic reactions.

Once the dissolutions are completed, the large beaker is installed in an ice bath on top of the magnetic stirrer. The two (2) other acidic solutions are then poured sequentially, one after the other, and slowly inside the 2 L beaker where this sequence completes first Step 110 in FIG. 1. Subsequently, the NaOH solution is slowly added by carefully pouring down small portions (approx. 5-10 mL/addition; 10 additions over a 50 minute period) inside the 2 L beaker in a sequential procedure (e.g., addition every 5 minutes, after having checked the temperature of the solution with the IR-thermometer) applying a constant magnetic stirring. This completes second Step 120 in FIG. 1.

The chemical composition of the NZF powder in the prototype manufacturing process are provided below in Table 1.

TABLE 1
Nickel Zine Ferrite Powder Composition

| Chemical | Molecular Weight | Weight (g) |
|---|---|---|
| NiCl₂•6H₂O | 118.445 | 2.86 |
| 0.5ZnCl₂ | 68.143 | 1.64 |
| 2FeCl₃ | 324.408 | 7.80 |
| 8NaOH | 319.976 | 7.70 |
| Total | 831.375 | 20.00 |

After 30 minutes, the expected ferrite powders are at the bottom of the beaker, and the mixture is stirred for another hour at room temperature. As depicted in third Step 130 in FIG. 1 a process of adding deionized water to remove any remaining chloride substances was executed over a period of seven days. After seven days of purifying the solution by changing the deionized water, the filtration process in fourth Step 140 in FIG. 1 was performed. The obtained suspension of ferrite powders in water being finally filtrated using a vacuum filtration system. Such a system may include a Buchner funnel top equipped with filter paper (with suitable dimensions), a 1 L or 2 L-filtration (collecting) flask, a silicone/rubber stopper, and proper tubing to connect the setup to a vacuum pump. The setup is safely held to a stand retort (or fume hood scaffold) with the help of a clamp. The filtration is performed by pouring down very slowly the mixture into the funnel top, while the vacuum pump is on. The beaker is rinsed with deionized water (2×50 mL) to ensure all the material is inside the funnel top. Once the first cycle is done, slowly disconnect the tubing from the collecting flask, slowly remove the Buchner funnel from it and discard the rinses in the suitable hazardous waste container used to accommodate waste. Once emptied, the collecting flask is re-installed under the Buchner funnel, and the tubing is reconnected (vacuum pump on) to ensure a more efficient drying process of the desired ferrite nano-powder. Once the paste is considered dry enough, the tubing is slowly disconnected from the collecting flask, and the vacuum system is switched off. The Buchner funnel equipped with the filter paper is carefully removed from the collecting flask. The resulting magnetic solid, what the inventors referred to as ferrite paste, is very gently transferred into a suitable resistant (chemically compatible with the nanoparticles) box with the help of a plastic spatula/spoon. The final fifth Step 150 of heating the ferrite paste at a defined temperature within a controlled environment is described below.

### Structural and Magnetic Properties Verification in Different Heating Atmospheres

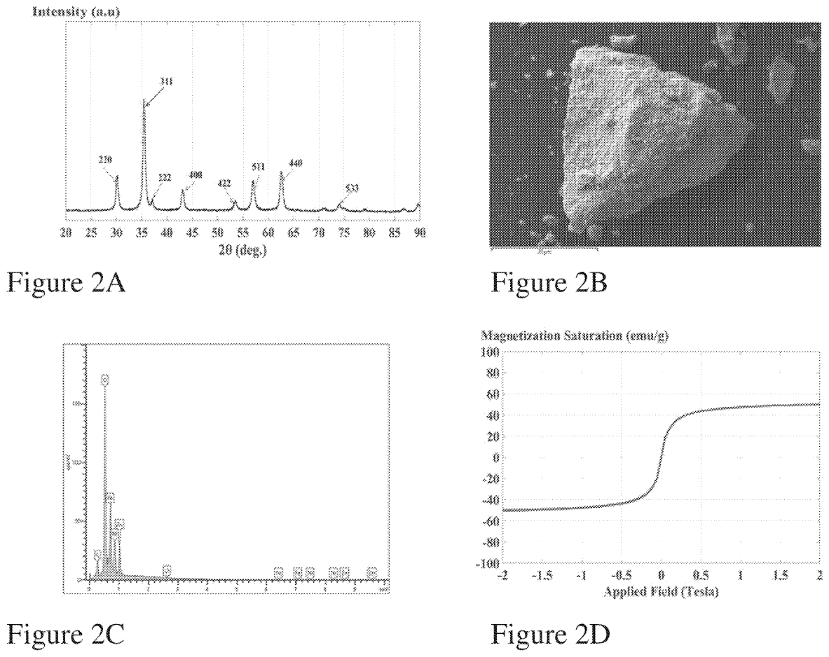

The phase of particle structure of the Ni_{0.5}Zn_{0.5}Fe₂O₄ material (hereinafter also referred to as NZF powder) was characterized by X-ray diffraction (XRD) analysis which was performed using a Bruker D8 Advance Diffractometer with Cu Kα radiation. The Ni_{0.5}Zn_{0.5}Fe₂O₄ powder was scanned over the range from 20° to 90° with a step size of 0.02° with a fixed integration time of 0.5 s. FIG. 2A depicts the XRD pattern for the ferrite Ni_{0.5}Zn_{0.5}Fe₂O₄ powder annealed at 550° C. where it is evident that the XRD indicates a single-phase spinel structure, implying the temperature was sufficient for the reaction to form desired spinel ferrites, with well-oriented textures.

From the phase versus the intensity diagram, it is visible that the highest peak is obtained at 35.42° corresponding to the (311) plane. It is worth to the point that the crystallite size of the samples was calculated according to the (311) peak in the XRD patterns using Debye-Scherrer's Equation given in Equation (2) where λ=1.54060 Armstrong or 0.154060 nm which is the X-ray wavelength, θ is the Bragg's angle, β is the full width at half maximum (FWHM), D is the average crystallite size (nm), and k is the Scherrer constant. Since the diffractometer used for this work provides Cu Kα radiation.

D=kλ/β cos θ (2)

FIG. 2B depicts a scanning electron microscope (SEM) image of the nickel-zinc ferrite powder shows that most particles are of good crystalline nature and have a fine particle size. Within the processes employed by the inventors the ferrite powder was ground with a mortar and pestle as a cost-effective solution and hence it would evident that the grinding is not as uniform or as fine as may be achieved using ultra-fine powder grinding machines as known in the art. As the SEM is sensitive to ferrite powders, carbon tape was used where the ferrite powder was placed. From the energy-dispersive X-ray spectra (EDAX) in FIG. 2C as small amount of carbon is present with the other compositions. The EDAX confirms that the synthesized ferrite particles' elemental composition mainly contains Ni, Zn, Fe, and O elements with no other impure elements. A negligible amount of chloride (Cl) was still present from the co-precipitation process, where we have mixed the chlorides with NaOH but can be removed by refining the process and/or production machines rather than laboratory tools for general chemical processes. The magnetic properties of the NZF powder are verified using the vibration sample magnetometer (VSM) at room temperature. The VSM technique evaluates the magnetic properties of synthesized particles at ambient conditions, and the observed hysteresis (M-H) loops are presented in FIG. 2D. The M-H hysteresis loops clearly show the ferromagnetic nature of the samples. The NZF powder was measured at room temperature with an applied field of ±2 Tesla or 20000 (Oe). It is evident from the curve that the saturation magnetization obtained from the VSM is around 48.5 emu/g. The powder is almost saturated at a 1.5 T applied field, and a very smooth M-H loop can be observed.

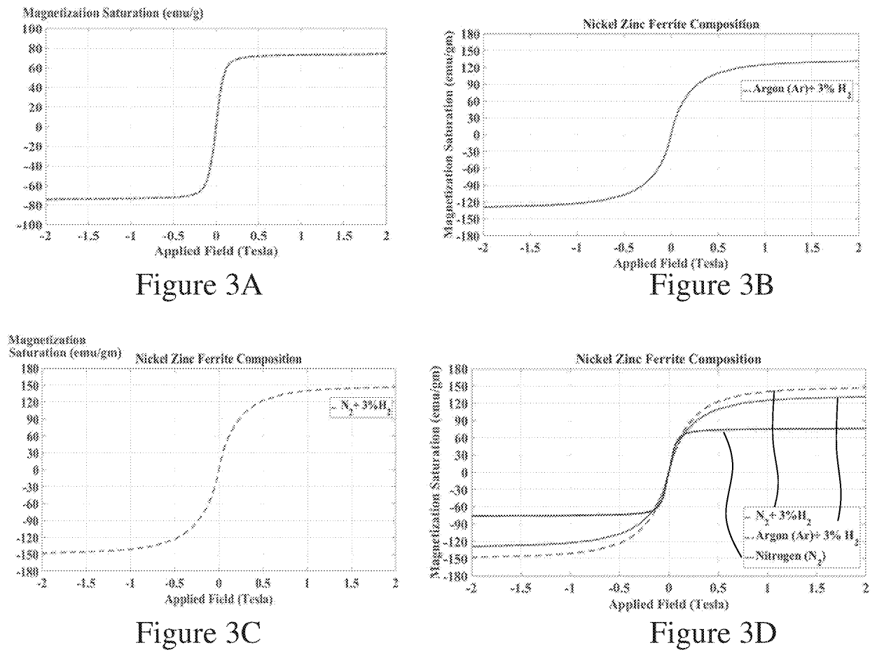

The first NZF powder sample, which was previously heated at 550° C. in the vacuum environment, was then heated again at 1100° C. but within a nitrogen environment to see a possible change in the saturation magnetization. FIG. 3A depicts the resulting M-H hysteresis loop curve at 1100° C. in the nitrogen environment that was heated previously to 550° C. under vacuum. A significant increase in the emu/g is observed after heating the powder at 1100° C. in the nitrogen environment. The NZF powder was measured at room temperature with an applied field of ±2 Tesla or 20000 (Oe). It is evident from the curve that the saturation magnetization obtained from the VSM is around 76 emu/g. The powder reaches almost saturation level at a 1 T applied field, and a very smooth M-H loop can be observed.

To verify the magnetization of the powder, two other experiments were conducted while performing heat treatments under an argon with 3% hydrogen atmosphere and a nitrogen with 3% hydrogen atmosphere. The M-H loop of these two heat treatments being depicted in FIGS. 3B and 3C respectively. It is worth pointing out that the maximum temperature the oven can handle is 1150° C., so we experimented with 50° C., less than the maximum temperature.

The samples calcined in argon with 3% hydrogen and nitrogen with 3% hydrogen show excellent stability with M-H loops exceeding 127 emu/g and 147 emu/g, respectively. The powder reaches almost saturation level at a 1.5 T applied field, and a very smooth M-H loop can be observed. FIG. 3D depicts a comparison of the magnetization saturation of the ferrite powder in under the thermal processing in nitrogen, argon with 3% hydrogen and nitrogen with 3% hydrogen atmospheres respectively, using VSM. It is evident that the NZF powder is highly magnetic and can be incorporated with microwave nonreciprocal components in the mm-wave spectrum, such as circulators, isolators, ferrite-based differential phase-shifters, etc. The thermal processing comprises a fifth Step 150 in FIG. 1.

After baking the powder, the next step required for ferrite elements in devices is to form the ferrite element. In this instance the inventors sought ferrite elements in disk form for microwave device demonstrations and as such formed a circular-shaped pellet which was then pressed within a hydraulic press machine. The maximum pressure the hydraulic press machine employed by the inventors could provide up to 2.5 tons of pressure.

### Ferrite Disk Fabrication Using Hydraulic Press Machine

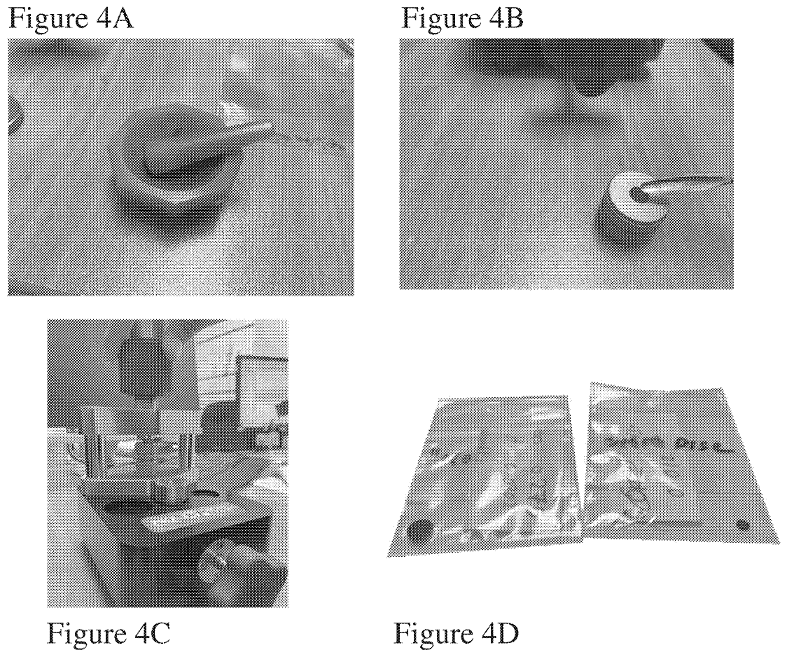

After baking the high-magnetization ferrite powder, the next step was to put the powder inside a circular-shaped pellet and press it with a hydraulic press machine. In the following part, we will describe in detail the production procedure and characteristics assessment process of the high-magnetization nickel zinc ferrite disk. The fabricated NZF powder was ground with a mortar and pestle as depicted in FIG. 4A. This method was accessible for grinding low-quantity powders and is a cost-effective solution although where there is a need for a larger quantity or mass production, it will require pulverizing the powders with an agitation mill for example to produce which also allows for ultra-fine particle sizes lower than those from simple mortar and pestle grinding.

The two critical factors for forming the disks are the applied force (F) and the surface area (A). For a larger disk, the surface area will be more extensive; thus, it will require more pressure to form the disk. The first disk that we fabricated has a diameter of 3 mm (0.125″). Therefore, 1.5-ton pressure is sufficient for developing the disk. Before deciding to go with 1.5-ton pressure, we tried pressing the disk at 2 tons but due to this heavy pressure, some portions of the pellet's back plate broke. It would be evident that with improved commercial manufacturing methods and equipment the appropriate pressures may be applied without yielding defects in the formed ferrite elements. Additionally, 7 mm (0.28″) disks were fabricated using this technique, where the maximum force of 2.5 tons was applied to form the ferrite disk. It is worth pointing out that the disk was considered 3 mm and 7 mm due to the available pellet size molds easily accessible commercially where the process of filling a mold is depicted in FIG. 4B. However, custom-made pellets and other non-disk geometries can be formed from the NZF powder without departing from the scope of the invention. Within the pressing performed by the inventors a solid back support; a bottom plate was also used. A small drop of isopropyl alcohol was poured on the powder prior to pressing where the hydraulic press employed is Pike Technologies, as shown in FIG. 4C where the black knob is rotated to increase the applied force.

Full pressure was applied for 3 minutes; the top cover was removed and flipped to remove the disk. The final step of ferrite disk production was heating the disk at 200° C. for 2 hours after fabricating it using the hydraulic machine. This heating will strengthen the disk which can then be incorporated with a circulator or isolator design for example. The final disks are shown in FIG. 4D.

Calculation of Saturation Magnetization 4πMs from the NZF Powder's emu/g:

After fabricating the NZF disks from the NZF powder, the weight of the disk was measured using the weighing scale. In addition, with the vernier scale, the diameter, and the height, were measured wherein the volume of the disk can be calculated using the cylindrical equation of the volume. The density of the ferrite disk then being known from the weight and volume of the disk. Table 2 shows the measured values of the fabricated disk, including the weight, volume, density, emu/g, and 4πMS. The conversion from emu/g in A/m to Gauss can be calculated from the Equation (3).

$$emu / g ( Ms ) \times density ( \frac{g}{{cm}^{3}} ) \times 1000 \times 4 π / 1000 = 4 π MS ( G ) \qquad ( 3 )$$

TABLE 2
Fabricated Nickel Zinc Ferrite Disks
Measured Dimensions and Performance

| Parameter | Value | |
|---|---|---|
| Weight (w) | 0.19 | g |
| Diameter (d) | 0.325 | cm |
| Height (h) | 0.0445 | cm |
| Volume (v = (πd²h)/4) | 0.00369 | cm³ |
| Density (d = w/v) | 5.148 | g/cm³ |

| | |
|---|---|
| Emu/g ( | 147 |
| 4πMS(G) | 9513 |

From Table 2 it is evident that the fabricated disk using the NZF powder according to an embodiment of the invention has a high magnetization, one which is significantly higher than the available ferrites in the market. To the inventors' knowledge the measured saturation magnetization 4πMs of 9500 G is 1.8 times higher than the magnetization of ferrite elements commercially available in the microwave and space industry.

The inventors have established that the annealing of NZF within atmospheres comprising an inert gas, such as nitrogen or argon for example, with hydrogen have increased saturation magnetization 4πMs when compared to those annealed within an inert atmosphere of nitrogen. Further, with respect to the NZF increased saturation magnetization 4πMs there is one or more of a threshold percentage hydrogen composition exists which should be exceeded, a threshold percentage hydrogen composition exists which should not be exceeded, that the inert gas has a secondary effect relative to the percentage of percentage hydrogen composition and that a relationship exists between annealing conditions, such as temperature and annealing time, and percentage hydrogen composition such that processing can be tuned to desired final magnetization saturation for cost reduction (e.g. by defining lower temperature and time).

### Electrical Characterization of Ferrite Material

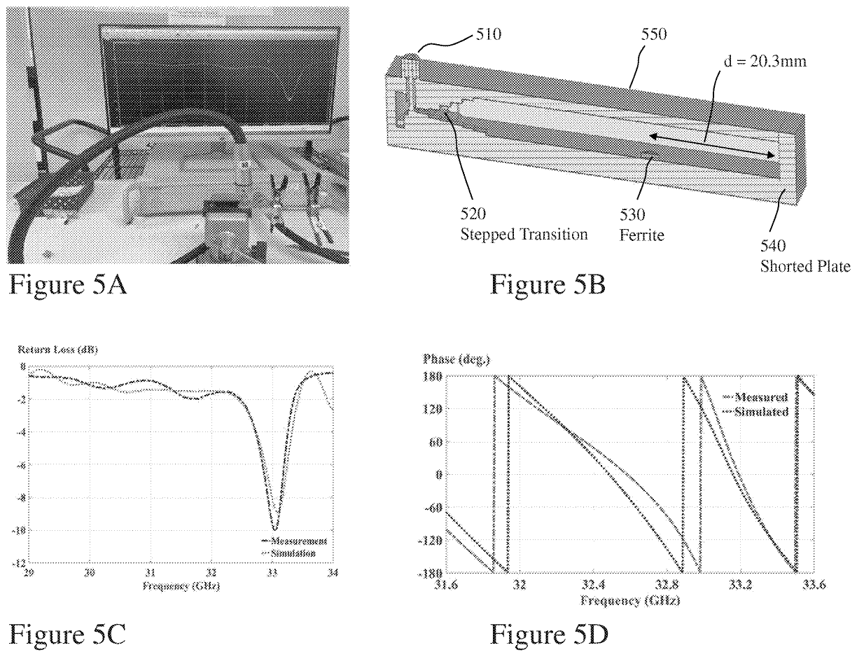

The inventors after fabricating prototype ferrite disks with the NZF, according to an embodiment of the invention, progressed to perform experiments using the ferrite disks within prototype microwave devices. Referring to FIG. 5A there is depicted a measurement setup for the electrical characterization of the fabricated ferrite disk with WR 28 waveguide for the measurements over the frequency range 29 GHz-34 GHz within the Kₐ band. From Equation (3), the ferrite magnetization in Gauss was calculated but the ferrite material's permittivity is an important parameter for the performance of the NZF ferrite within microwave and RF devices such as circulators. As depicted in FIG. 5B a ferrite Disk 5300 with 8500 G was inserted inside into the WR28 Waveguide 550, where a Coaxial Probe 510 was used to excite the ferrite Disk 5300 via a Stepped Transition 520. The WR28 Waveguide 550 being terminated with a Short Circuit 540 to perform the measurements presented in FIGS. 5C and 5D respectively. The location of the ferrite Disk 550 was moved to observe any possible resonance. After moving the ferrite Disk 550 20.3 mm (0.80″) from the shorted plate providing the Short Circuit 550 a resonance at 33 GHz was observed as evident from the return loss plotted in FIG. 5C.

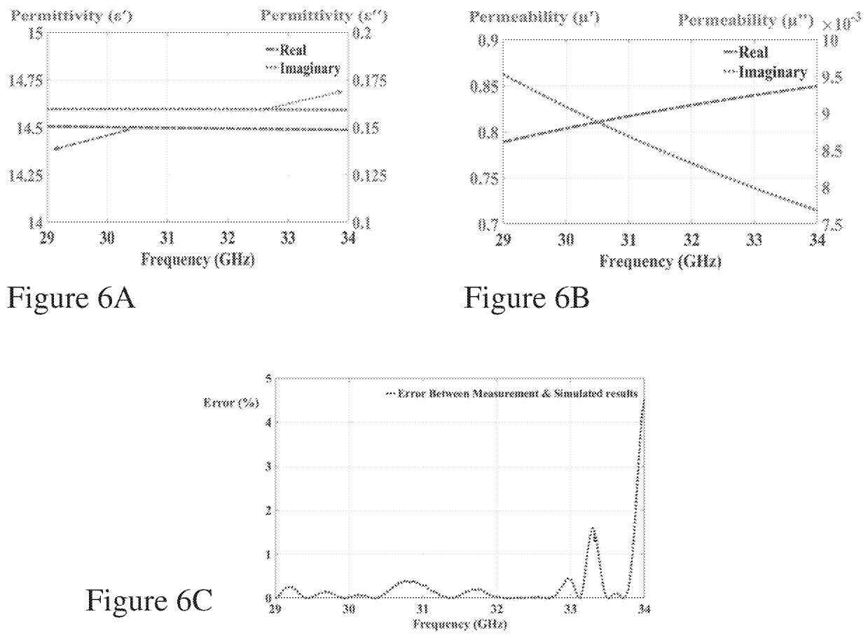

The adapter dimensions and the location of the ferrite Disk 550 were then employed to perform a simulation. At the simulation's starting point, the inventors set the ferrite's permittivity as 10 where a series of parametric studies were performed using CST Microwave Studio to predict the permittivity of the ferrite. The comparison of the simulation and measurement results are presented in FIG. 5D when the NZF ferrite permittivity was permittivity was set to 14.5 with a loss tangent, tan(δ)=0.0115, and permeability of 0.83μ₀. It is noticed that there is a phase difference between the simulated and measured results, which could be from the cable used to perform the measurement using the vector network analyzer (VNA) and also the connector. In the simulator, we have just considered the coaxial probe; however, there was a coaxial connector in the measurement setup. The coaxial connector has a certain length which can change the phase as this length is not known. FIGS. 6A and 6B depict the real and imaginary parts of the permittivity and permeability. The prediction error of the proposed technique can be estimated from Equation (4) where this is presented in FIG. 6C.

The error percentage is highlighted in FIG. 6(c) to predict the estimated error between the measured and simulated response where it is evident that there is excellent prediction for the simulated response with respect to the measurement response. As evident over the frequency range of 29.0-33.2 GHz, the error percentage is less than 1%, with respect to the predicted parameters of the ferrite material.

Error(Percentage)=|S₁₁,measured−S₁₁,simulated|² (4)

Ka-Band Circulator with Fabricated Ferrite Disk

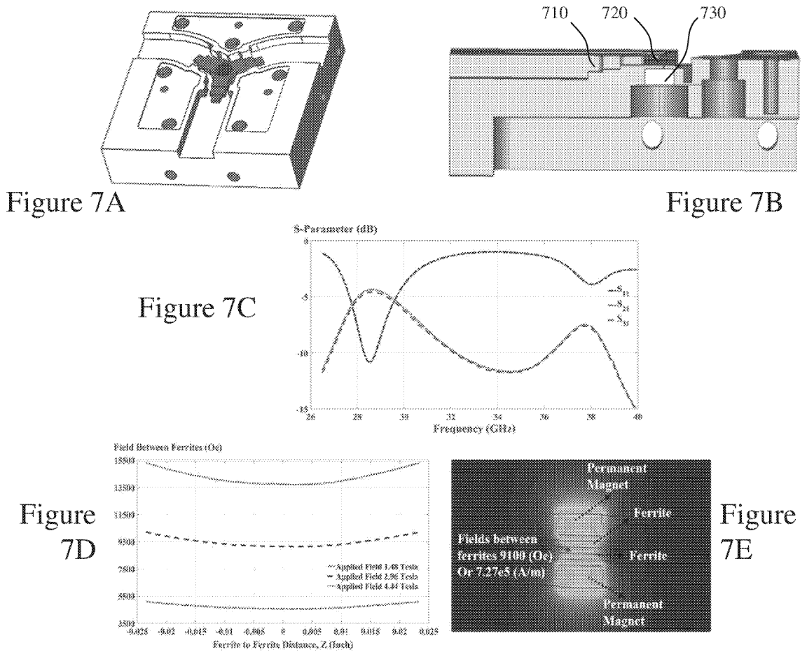

To further validate the NZF ferrite performance the inventors fabricated and measured a Kₐ band circulator manufactured using computer numerical controlled (CNC) milling with a 0.0635 mm (0.0025″) tolerance. The 3D view and cross-sectional view of the base plate of circulator are depicted in FIGS. 7A and 7B respectively wherein the Stepped-Transformer 710 to or from the waveguide is depicted, the ferrite Disk 720 and the Permanent Magnet 730. DC magnets are placed on both sides of the circulator for proper magnetic biasing. The magnet wall thickness is kept at 0.38 mm (0.015″) for the fabricated prototype. Reducing the wall thickness can increase the fields between the two ferrites. The prototype circulator was biased using Neodymium N52 magnets with a magnetization of 1.48 Tesla or 14800 G. The measured circulator showed no microwave signal circulation with the fabricated high-magnetization ferrite disk, as shown in FIG. 7C. Even after applying more magnets from both the top and bottom sides, there is no sign of possible circulation. To verify this, we have followed two possible steps. The first step was to ensure whether the magnetization was still the same. The magnetization of the nickel-zinc-ferrite (NZF) powder was established above using the VSM measurement on the powder. However, it was not measured after compressing the disk from the powder. Accordingly, the inventors verified the magnetization of the NZF disk, formed from the NZF powder which was heated under the argon with 3% hydrogen atmosphere and observed that the emu/g increased by 20-25% from the previous measurement from 127 emu/g to 160 emu/g. The rise in emu/g indicates that the ferrite disk has very high magnetization, and the newly calculated disk magnetization is 10700 G instead of 8500 G. In other words, the proposed disk magnetization is more than double the magnetization of the highest commercially available ferrite disk in the market.

In the second step, the inventors incorporated the permanent magnet's magnetization value using the M-static solver of CST MICROWAVE STUDIO to evaluate the possible magnetic field at the center of the two-ferrite disks. This would indicate the magnetic field required to bias a circulator with the available permanent magnet. For this step, we have considered an available ferrite disk with 5300 G magnetization with similar ferrite dimensions to the proposed disk. The circulator is simulated and measured with the new 5300 G commercially available disk, which shows a good agreement. The applied external magnetic field for the measurement is 14800 G from the permanent magnet. The applied external magnetic field for the measurement is 14800 G from the permanent magnet. Using a permanent magnet with 14800 G, a maximum field of around 4550 (Oe) can be obtained between the two ferrites based on the M-static solver. Accordingly, a 4550 (Oe) field is capable of biasing a ferrite with 5300 G magnetization. However, in our case, the magnetization of the ferrite is doubled, 10700 G instead of 5300 G. Accordingly, the field between the two ferrites 4550 (Oe) is not sufficient to bias the circulator with a ferrite magnetization of 10700 G. The field can be enhanced in two ways, by reducing the magnet wall thickness and by using a permanent magnet, which provides double the magnetization of a N52 Neodymium magnet. In the commercial industry, the highest magnetization for the permanent disk magnet is 14800 G, which we have already used. Therefore, it is not possible to bias such a high-magnetization ferrite disk with the current permanent disk magnet. To explain this point, we have performed simulations using the M-static solver by doubling and tripling the magnetization. It is evident from FIG. 7D that increasing the permanent magnet's magnetization increases the fields (Oe) between the ferrites, which can bias the circulator with the fabricated ferrite disk with the NZF power according to the embodiment of the invention. FIG. 7E shows the magnetic field distribution at the center of the junction with an external field of 2.96 T or 29600 G. It is evident that at the center of both ferrites, the magnetic field is 9100 (Oe). This is the minimum field amount required to bias the circulator with 10700 G ferrite disks formed using the NZF powder according to an embodiment of the invention. Providing this extreme field magnitude at the center of the junction is only possible with a permanent magnet with a strong magnetization of 2.96 T.

It is worth noting that the proposed circulator design has considered a ferrite magnetization of 8700 G, so the matching level of the circulator, return loss, and isolation levels will not be good with a low magnetization ferrite disk. Because while performing the full-wave simulation and optimization, an 8700 G magnetization is considered. To make a circulator work with a low-magnetization ferrite disk, the whole circulator design needs another optimization based on the new ferrite disk's magnetic properties and a new fabrication for the circulator design. To validate our proposed NZF disk fabrication process, a lower magnetization powder is processed and compressed to form ferrite discs. Then, the lower magnetization discs were employed in the design and assessment of another Ka-band circulator.

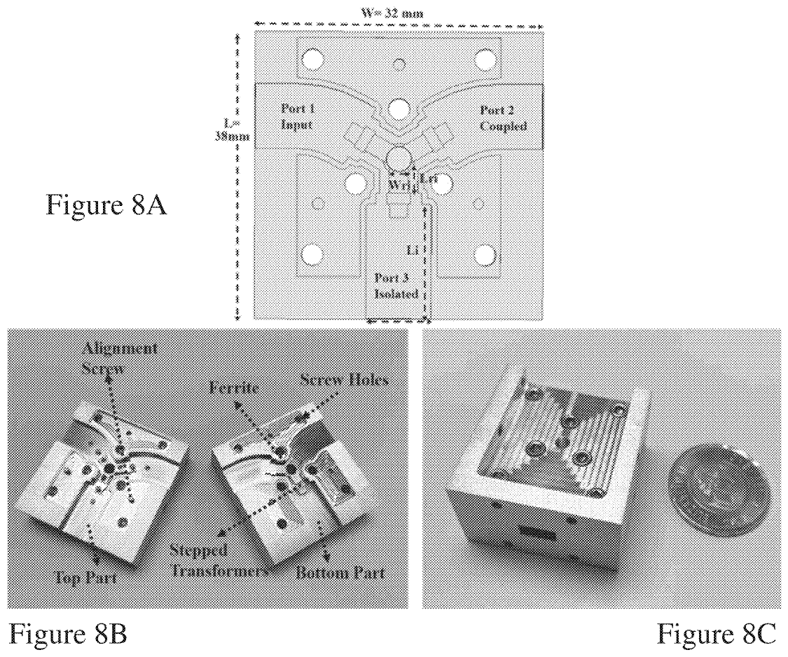

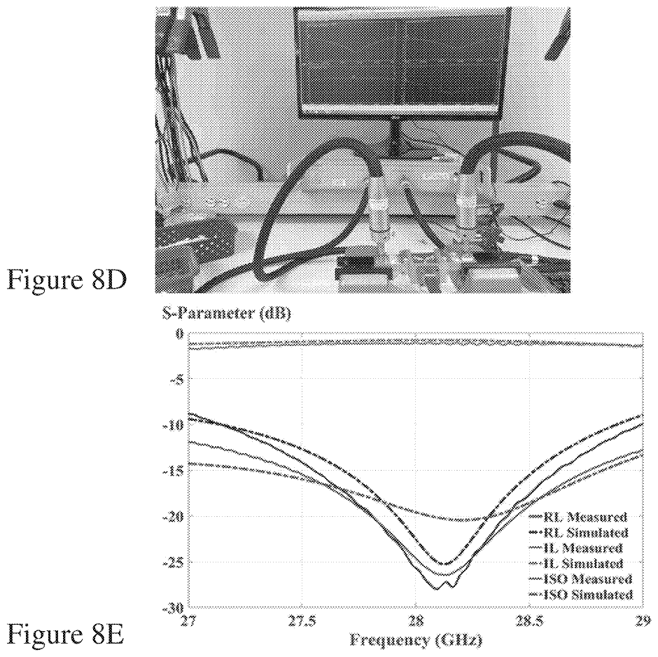

In this instance the circulator was fabricated for experimental validation using CNC milling with a mm (0.0005″) tolerance. The simulated model of the WR34 waveguide based circulator design is shown in FIG. 8A. The fabricated Ka-band rectangular waveguide circulator prototype with 4200 G ferrite is shown in FIGS. 8B and 8C where the fabricated ferrite is placed at the center junction. The circulator being 38 mm (1.50″) long and 32 mm (1.26″) wide with stepped transformers on each of the input Port 1, coupled Port 2 and isolated Port 3 with stepped transformers on each port between the central portion with the ferrite disk and the WR34 waveguides on each port. A small amount of silicone was used at the center of the circulator's ferrite junction to hold the ferrite disk in place. DC magnets were placed on both sides of the circulator for proper magnetic biasing. Since the magnetization of the ferrite considered here is much lower than the previous ferrite, we have tried to incorporate it for a lower frequency band circulator, Q-band, using WR 34 rectangular waveguide. Table 3 shows the ferrite disk design parameters, biasing, and material properties. The design parameters of the WR34 Ka-band circulator, including the matching transformers, are shown in Table 4.

TABLE 3
Design Parameters of Ferrite Disk

| Parameter | Value | |
|---|---|---|
| Gyrotropy gₖ | 0.6 | |
| Magnetic Saturation 4πMs | 4200 | G |
| Magnetic Biasing Ratio α | 0.4 | |
| Magnetic Biasing Field H₀ | 1700 | Oₑ |
| Disc Radius a | 1.5 | mm |
| Ferrite Disc Height h_{f} | 0.5 | mm |

| | |
|---|---|
| Effective Gyromagnetic Ratio | 2 |
| Ferrite Permittivity | 14.5 |

TABLE 4
Dimensions of Q-Band Circulator Design (in mm)

| Parameter | Value | Parameter | Value |
|---|---|---|---|
| W1 | 5.68 | L1 | 5.08 |
| W2 | 3.73 | L2 | 1.8 |
| W3 | 4.62 | L3 | 2.13 |
| Wr1 | 2.48 | Lr1 | 2.0 |
| Wr2 | 2.43 | Lr2 | 1.69 |
| Wr3 | 1.43 | Lr3 | 1.28 |
| Hr1 | 0.93 | Hr2 | 0.63 |
| Hr3 | 0.47 | | |

Before the measurement of the circulator, a waveguide calibration is done. The fabricated circulator was measured using a VNA as depicted in FIG. 8D. Since the VNA just had two ports, the third port of the circulator is terminated by a matched load. So, S21 is the insertion loss, and S12 is the circulator isolation. The return losses of the circulator for Ports 1 and 2 are denoted with S11 and S22, respectively. The simulated and measurement response comparison is presented in FIG. 8E over the frequency range 27 GHz-29 GHz. It is evident from the simulation and measurement response that there is an excellent agreement between them where the circulator provides 7% bandwidth. The measured isolation and return loss is below −20 dB at the center frequency of 28 GHz and the insertion loss varies from 0.8±0.6 dB over the operating range of the circulator. It is worth noting that whilst performing the measurement and tuning screws are used only on the second sections of the stepped transformers of all three ports. The first transformer tuning screw had almost no effect on the matching level. The height of the tuning screws from the second transformers for the input, coupled, and isolated ports were T1=0.55 mm, T2=0.59 mm, and T3=0.62 mm. The dimensions of the height of the tuning screws were verified using a Dynamic Gage meter, and were employed in the simulator to verify the results with the measurement response.

The prototype ferrite disks were fabricated from the NZF powder according to an embodiment of the invention using a manual 2.5-ton hydraulic press which provides a low-cost and simple solution for the laboratory level demonstrations of the novel NZF powder and ferrite disks formed using it. However, the manufacturing process had some limitations, especially in ensuring the exact ferrite height and the flatness on the surface or surface roughness. Although the proposed technique can be helpful, it can deteriorate the circulator performance in the mm-wave spectrum due to surface roughness. The ferrite has to sit correctly on the circulator junction for an excellent performance. If the surface is not flat, it will create more air gaps. Due to an asymmetric surface, the magnetization applied from the permanent magnet cannot be uniformly distributed over the ferrite surface, tremendously affecting the performance. Such issues can be addressed and minimized by using more effective production equipment which can control the ferrite surface roughness and height. This will ensure a flat ferrite surface which can significantly enhance the circulator operating bandwidth. Although the commercially available disks can cover more extensive bands, our fabricated circulator with similar magnetization did not provide a wideband performance due to ferrite surface roughness.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device for processing microwave signals comprising:
an element formed from a compressed nickel zinc ferrite (NZF) powder formed with a predetermined geometry; wherein
the NZF has a saturation magnetization exceeding at least one of 8,000 Gauss, 9,000 Gauss and 10,000 Gauss; and
the NZF has the composition Ni_{0.5}Zn_{0.5}Fe₂O₄.

2. The device according to claim 1, wherein
NZF powder was fabricated by a process comprising:
forming a paste comprising the NZF by employing a chemical co-precipitation process and filtering process;
heating the initial paste under defined conditions to calcine the paste to yield an initial NZF particles;
grinding the initial NZF particles to form the NZF powder;
heating the NZF powder within other defined conditions.

3. The device according to claim 2, wherein
the defined conditions include under vacuum; and
the another defined conditions include an atmosphere is one of nitrogen and argon with a percentage of hydrogen.

4. The device according to claim 2, wherein
the defined conditions include under vacuum and a temperature of 550° C.; and
the another defined conditions include a temperature of 1,100° C. and an atmosphere of one of nitrogen and argon with three percent hydrogen.

5. A method comprising:
forming an NZF powder with a process comprising:
forming a paste comprising the NZF by employing a chemical co-precipitation process and filtering process;
heating the initial paste under defined conditions to calcine the paste to yield an initial NZF particles;
grinding the initial NZF particles to form the NZF powder;
heating the NZF powder within other defined conditions;
forming the NZF powder into a defined geometry; and
compressing the NZF powder to form a ferrite element; wherein
the NZF has a saturation magnetization exceeding at least one of 8,000 Gauss, 9,000 Gauss and 10,000 Gauss; and
the NZF has the composition Ni_{0.5}Zn_{0.5}Fe₂O₄.

6. The method according to claim 5, wherein
the defined conditions include under vacuum; and
the another defined conditions include an atmosphere is one of nitrogen and argon with a percentage of hydrogen.

7. The method according to claim 5, wherein
the defined conditions include under vacuum and a temperature of 550° C.; and
the another defined conditions include a temperature of 1,100° C. and an atmosphere of one of nitrogen and argon with three percent hydrogen.

8. The method according to claim 5, further comprising
employing the ferrite element within a device processing microwave signals.
